(19) United States
(12) Patent Application Publication
(10) Pub. No.: US 2016/0313160 A1
(43) Pub. Date: Oct. 27, 2016

(54) APPARATUS AND METHOD FOR DETERMINING CONCENTRATIONS OF COMPONENTS OF A GAS MIXTURE

(71) Applicant: Endress+Hauser Flowtec AG, Reinach (BL) (CH)

(72) Inventors: Pierre UEBERSCHLAG, Saint-Louis (FR); Michal BEZEDK, Aesch (CH)

(21) Appl. No.: 15/102,983

(22) PCT Filed: Nov. 14, 2014
(86) PCT No.: PCT/EP2014/074627

§ 371 Date: Jun. 9, 2016

(30) Foreign Application Priority Data
Dec. 19, 2013 (DE) 10 2013 114 538.8
Jan. 31, 2014 (DE) 10 2014 001 165.8

(51) Int. Cl. G01F 1/74; G01N 29/024; G01N 29/32; G01F 1/66

(52) U.S. Cl. CPC G01F 1/74; G01F 1/667; G01N 29/024; G01N 29/326; G01N 2291/0215; G01N 2291/0212

(57) ABSTRACT

The invention relates to an apparatus for determining concentrations (x₁,x₂) of components of a gas mixture (2) flowing through a pipeline (1), wherein the gas mixture (2) is essentially composed of two or three components, wherein an ultrasonic, flow measuring device (31) is provided, which determines velocity (C_{g}) of sound of the gas mixture (2) flowing in a pipeline (1), wherein a temperature measuring unit (12) is provided, which determines temperature (T) of the gas mixture (2) flowing in the pipeline (1), and wherein an evaluation unit (21) is provided, which, based on velocity of sound (C_{g}) ascertained via ultrasonic measurement and based on velocity of sound (Cₜ) resulting from evaluation of the real gas equation, determines the concentrations (x₁,x₂) of the components of the gas mixture (2).

The invention relates to an apparatus and to a method for determining concentrations and/or flow of individual components of a gas mixture, wherein the gas mixture flows through a pipeline, respectively through a measuring tube.

Normally in the case of measuring the flow of gas mixtures through a pipeline, a thermal flow measuring device is used. In order to be able to perform an as exact as possible measuring, the composition of the gas mixture must be known. For this, a gas analyzer is provided in addition to the thermal flow measuring device. The corresponding gas analysis occurs offline, i.e. a gas sample is removed from the gas mixture for the purpose of analysis, filled into the gas analyzer and there analyzed. Before performing a next analysis, the analyzer must be cleaned. This known method is relatively costly as regards acquisition- and operating costs.

WO2008/003627A1 discloses a method and an apparatus for ascertaining concentrations and/or flow of individual components of a gas mixture. This uses the ideal gas equation and is a very good method for application to a large number of gases in a limited temperature and pressure range.

An object of the invention is to provide an apparatus and a method for precisely determining concentration of individual components of a gas mixture of more than two components over an expanded pressure- and temperature range.

The object is achieved by features including that an ultrasonic, flow measuring device is provided, which determines velocity of sound in the gas mixture flowing in a pipeline, a temperature measuring unit is provided, which determines temperature of the gas mixture flowing in the pipeline, and an evaluation unit is provided, which, based on velocity of sound ascertained via ultrasonic measurement and based on velocity of sound resulting from evaluation of the real gas equation, determines concentrations of the individual components of the gas mixture, wherein the evaluation unit ascertains concentration of steam as a function of temperature and humidity of the gas mixture and takes concentration of steam into consideration in determining the concentrations of the two additional components. As stated above, velocity of sound is preferably ascertained by solving the real gas equation. For increasing accuracy of measurement, it is alternatively possible to obtain this information based on experimentally ascertained data.

Fundamentally, the real gas equation has been known for more than a century. Implementing the real gas equation in the case of evaluating sound velocity values in an ultrasonic flow measurement device enables a multifunctional device, which is able to measure both flow as well as also gas composition and this even at high process pressures and process temperatures.

Especially in this connection, it is provided that the gas mixture can be any binary gas mixture. The apparatus can also be utilized in the case of ternary gas mixtures having one known component.

Especially, it is provided in connection with the present invention that the gas mixture is a gas composed essentially of the components, methane, carbon dioxide and steam.

Such gas mixtures are e.g. biogases, wherein also digester gases fall under the definition of a biogas

In an advantageous embodiment of the apparatus, it is provided that the evaluation unit ascertains concentration of steam as a function of temperature assuming a relative humidity of 100%.

The above stated assumption of saturation of the gas mixture with steam is at least approximately correct in many cases. Especially, such holds for biogas, which is usually produced at a temperature of 37° C. However, this approximation does not deliver a correct result in all cases: In order to minimize the possibly error in determining concentration of steam, according to an advantageous further development of the apparatus, a humidity measuring unit is provided, which measures the relative humidity of the gas mixture flowing in the pipeline; then the evaluation unit determines the concentration, respectively the volume fraction, of the steam as a function of temperature and the measured relative humidity.

Since also the pressure of the gas mixture flowing in the pipeline has an influence on the concentration of the steam in the gas mixture, according to a further development of the apparatus, a pressure sensor is provided, which determines the absolute pressure of the gas mixture flowing in the pipeline; the evaluation unit takes the measured absolute pressure into consideration in determining the concentration of the steam in the gas mixture.

In a preferred application of the apparatus, the pipeline is a removal tube for biogas, wherein the removal tube is arranged in the upper region of a fermenter, in which biomaterial is located.

In order to ascertain and to monitor the effectiveness of a biogas plant, it is necessary to know the current flow and the current concentrations of the essential components of the biogas. Thus, the percentage of methane in the gas mixture determines the energy content of the biogas, while the fraction of the methane in the biogas is a variable linked with the flow, which characterizes the energy production, respectively the energy winnings, of the biogas plant. Furthermore, the ratio of methane to carbon dioxide is an important control variable for the process running in the fermenter; this ratio can be used, for example, for controlling the process temperature and/or for controlling the charging of the fermenter with new biomaterial. Furthermore, monitoring the fraction of carbon dioxide in the biogas is of great importance due to existing environmental protection specifications.

In a preferred embodiment of the method, the ultrasonic, flow measuring device is so embodied that it ascertains the flow velocity, respectively the volume flow, of the gas flowing in the pipeline according to the Doppler- or according to the travel-time difference principle. The ultrasonic, flow measuring device, is either an inline flow measuring device or a clamp-on flow measuring device.

Ultrasonic, flow measuring devices, which work according to the travel-time difference principle, have at least one pair of ultrasonic sensors, which alternately transmit and/or receive the ultrasonic, measurement signals along defined sound paths through the gas mixture flowing in the pipeline. A control/evaluation unit ascertains the volume- and/or the mass flow of the gas mixture based on the difference of the travel times of the measurement signals in the stream direction and counter to the stream direction of the gas mixture. And essential advantage of the apparatus is that information concerning flow and composition of the biogas composed essentially of three components can be provided inline and continuously.

In the case of inline flow measuring devices, the ultrasonic sensors are fixedly integrated into corresponding cavities in the wall of a measuring tube. The measuring tube is inserted into the pipeline by means of flanges. In the case of clamp-on flow measuring devices, the ultrasonic, sensors are mounted externally on the pipeline; they measure through the pipe wall the volume-, respectively mass flow, of the gas mixture in the pipeline.

Ultrasonic, flow measuring devices of the above described type, which ascertain volume- or mass flow, are widely applied in process and automation technology. Clamp-on flow-measuring devices have the advantage that they enable determination of volume- or mass flow in a containment, e.g. in a pipeline, without contact with the medium. Clamp-on flow measuring devices are described, for example, in EP 0 686 255 B1, U.S. Pat. No. 4,484,478, DE 43 35 369 Cl, DE 298 03 911 U1, DE 4336370 C1 and U.S. Pat. No. 4,598,593.

In the case of both types of ultrasonic, flow measuring devices, the ultrasonic, measurement signals are radiated into, respectively from, the pipeline at a predetermined angle with respect to the pipeline, in which the fluid medium is flowing. In the case of ultrasonic, flow measuring devices, the particular position of the ultrasonic transducer on the measuring tube (inline), respectively on the pipeline (clamp-on), depends on the inner diameter of measuring tube and on the velocity of sound in the medium. In the case of clamp-on flow measuring devices, the application parameters, wall thickness of the pipeline and velocity of sound in the material of the pipeline, must be supplementally taken into consideration.

Usually in the case of both types of ultrasonic, flow measuring devices, the ultrasonic sensors are so arranged that the sound paths are sent through the central region of the pipeline, respectively of measuring tube. The ascertained volume- or mass flow reflects, thus, the average flow of the medium through the pipeline. In the case of many applications, especially in the case of flow measurements in pipelines with large nominal diameters, this averaging is, however, too inaccurate. Known from the state of the art is distribution of a plurality of sensor pairs over the periphery of the measuring tube, respectively pipeline, whereby information concerning flow of different segmented angular regions of the measuring tube, respectively the pipeline, is provided.

An essential component of an ultrasonic sensor is a piezoelectric element. The essential component of a piezoelectric element is a piezoceramic layer in the form of a film or membrane. At least a portion of the piezoceramic layer is metallized. By applying an electrical exciter signal, the piezoelectric layer is caused to execute a resonant oscillation, and ultrasonic, measurement signals are transmitted. At the receiving ultrasonic sensor, the ultrasonic, measurement signals are converted into an electrical signal.

In an advantageous embodiment of the apparatus, the evaluation unit ascertains, based on the earlier determined concentrations and the molecular weights of the individual components of the gas mixture, respectively of the biogas and based on the ascertained flow velocity, the volume- or mass flow of at least one of the components of the gas mixture, respectively of the biogas.

Preferably, the evaluation unit ascertains the energy flow, respectively the energy production, of the biogas taking into consideration the ascertained concentrations of the individual components and the volume flow of the biogas in the pipeline.

Furthermore, a display unit is provided, which outputs a report, when the energy flow, respectively the energy production, of the biogas subceeds a predetermined minimum limit value.

It is advantageous, when the flow measuring device has a control/evaluation circuit and a circuit of the temperature sensor is integrated into the control/evaluation circuit.

It is additionally advantageous, when the measuring tube has a mechanical interface, especially a bore hole or a connection nozzle, for mounting a pressure sensor on or in the measuring tube. Fundamentally, a pressure measurement can occur before or behind the flow measuring device. The present arrangement enables a user, however, to perform a pressure measurement at the site of the flow measurement by installation of a pressure measuring device. This option is available to the user. A pressure measuring device must, in such case, not absolutely already be installed in the interface.

It is advantageous when the measuring tube has a pressure sensor, which especially is mounted via the above interface on or in the measuring tube and the data transfer between the pressure sensor and the control/evaluation circuit occurs via an analog or digital interface, especially a 4 . . . 20 mA data transfer interface or a HART data transfer interface. In this way, the transmitters of the flow measuring device and the pressure sensor can communicate with one another.

The evaluation unit undertakes advantageously the ascertaining of the two unknown concentrations of the gas mixture taking into consideration the type of the gas components and these concentrations are provided as input values. These inputs values can be provided as ‘a priori’ known data by the customer.

The evaluation unit is embodied in such a manner that it ascertains the two unknown concentrations of the gas components of the gas mixture taking into consideration a third to n-th concentration of additional gas components of the gas mixture, which are provided as input values or, in the case of the water content, are, in given cases, ascertained based on relative humidity or based on dew point. In this way, the flow measuring device can, depending on application, also be applied for concentration of two gas components in the case of ternary or quaternary gas mixtures.

An especially advantageous embodiment of the apparatus provides a controller, which so controls temperature of the fermenter and/or the charging of the fermenter with material that the energy flow, respectively the energy production, of the biogas assumes an essentially constant value. In this way, the running of the fermentation process can be optimized. Preferably used for this purpose are the above mentioned control variables.

If the plant for producing biogas is composed of a plurality of fermenters, then a preferred embodiment of the apparatus provides that the controlling of the temperature of each individual fermenter and/or the charging of each individual fermenter with material is controlled in such a manner that the energy flow, respectively the energy production, of the biogas produced by the plant assumes an essentially constant value. In this way, likewise an optimizing of the process flow is achieved.

Regarding the method, the object is achieved by features including that velocity of sound in the gas mixture flowing in a pipeline is determinesd via an ultrasonic, measuring method, that the temperature of the gas mixture flowing in the pipeline is determined, that concentration of steam is ascertained as a function of temperature in the case of the humidity reigning in the pipeline, and that based on the velocity of sound ascertained via the ultrasonic, measuring method and based on velocity of sound resulting from evaluation of the real gas equation, the concentrations of the two additional components of the gas mixture are determined.

A preferred embodiment of the method provides that the energy flow, respectively the energy production, of the gas mixture is determined taking into consideration the concentrations of the individual components'and the volume- or mass flow through the pipeline.

Exactly in the case of higher pressures, a flow measuring device, which ascertains the flow and the individual component concentrations of a gas mixture based on a mathematical, physical model for real gases, has special advantages. In such case, the concentrations of ideal gases deviate increasingly from the actual values. Therefore, the application of a flow measuring device as above defined is especially preferred in the case of pressures of the medium of greater than 10 bar, especially greater than 20 bar.

The invention will now be explained in greater detail based on the appended drawing, the figures of which show as follows:

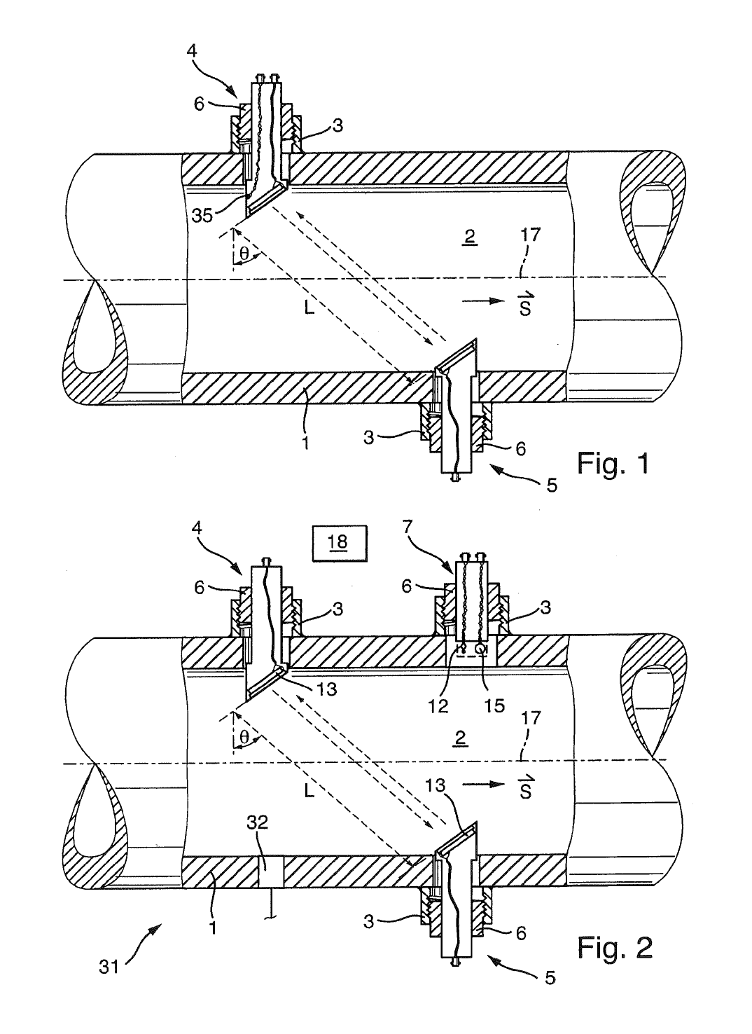

FIG. 1 a longitudinal section through a first form of embodiment of the ultrasonic, flow measuring device,

FIG. 2 a longitudinal section through a second form of embodiment of the ultrasonic, flow measuring device,

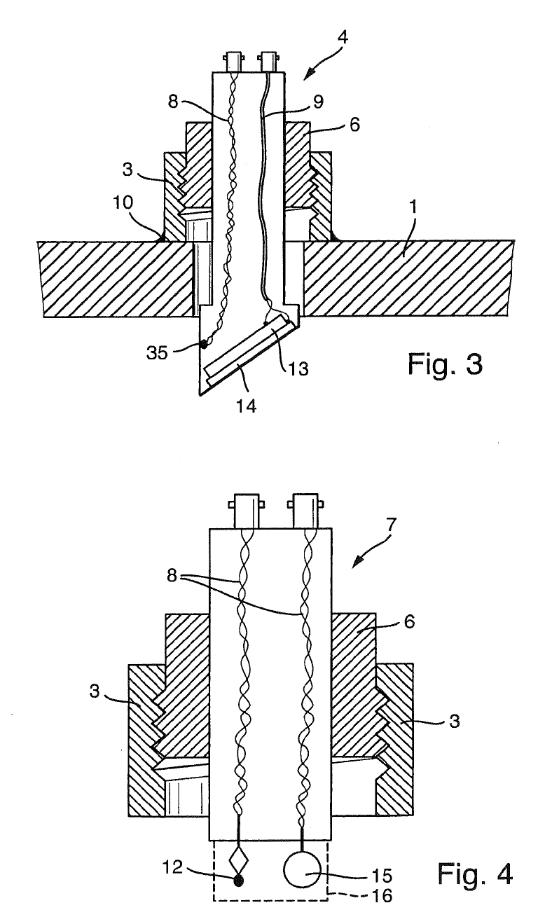

FIG. 3 a longitudinal section through an ultrasonic sensor applied in connection with the form of embodiment shown in FIG. 1,

FIG. 4 a longitudinal section of the embodiment of a temperature- and humidity sensor shown in FIG. 2,

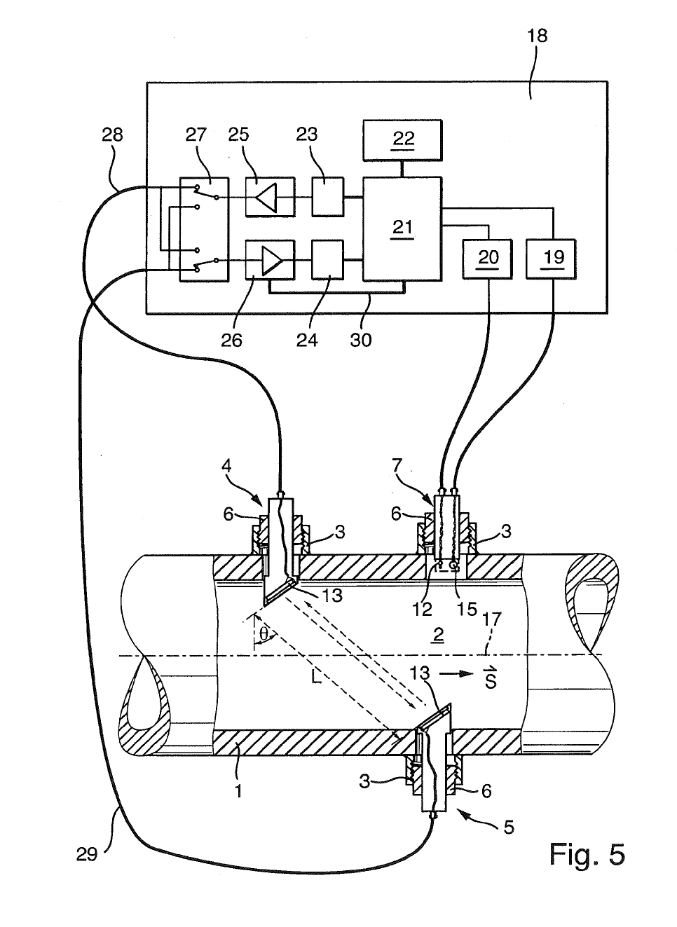

FIG. 5 circuit arrangement of the ultrasonic, flow measuring device,

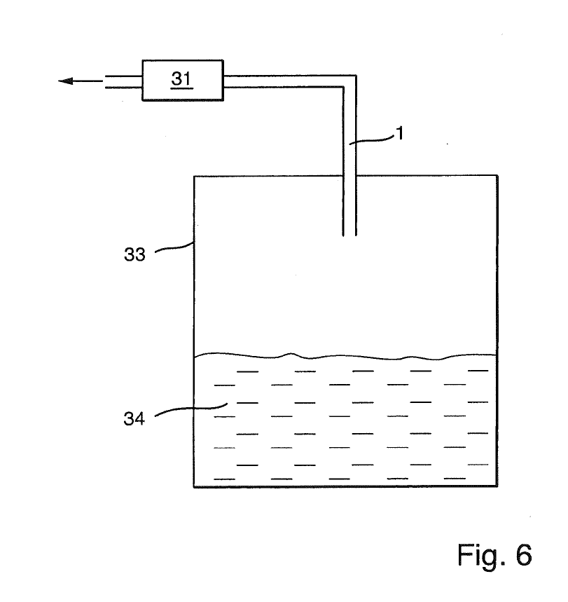

FIG. 6 a schematic representation of the arrangement of the apparatus on a fermenter,

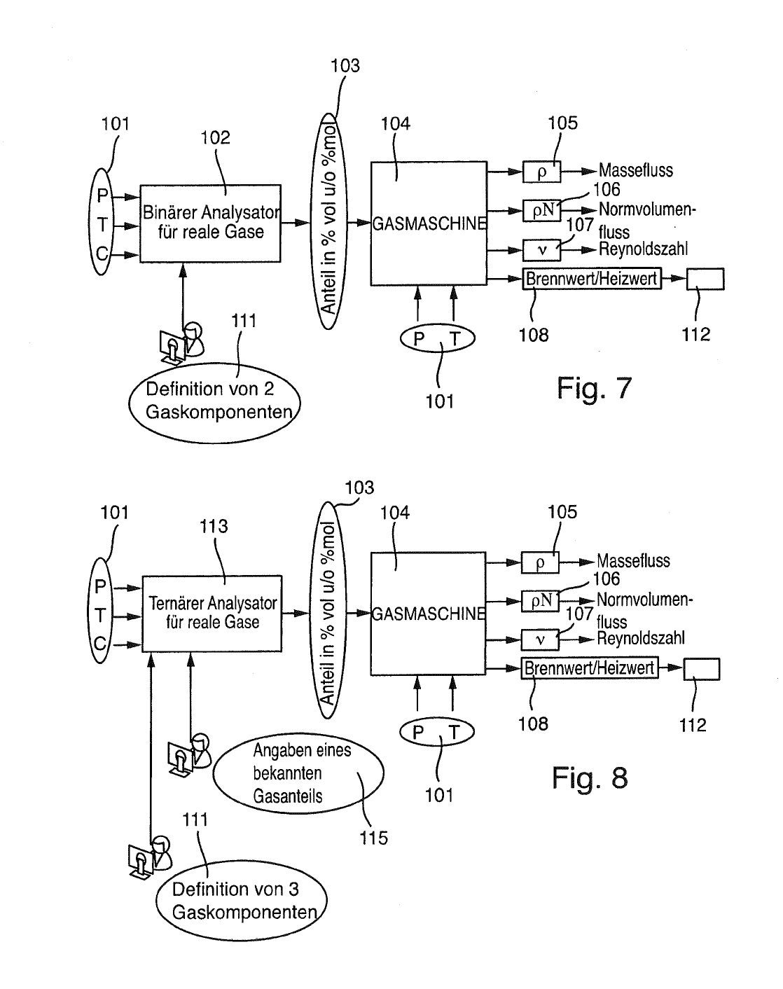

FIG. 7 schematic flow diagram for analysis of binary gas mixtures,

FIG. 8 schematic flow diagram for analysis of ternary gas mixtures,

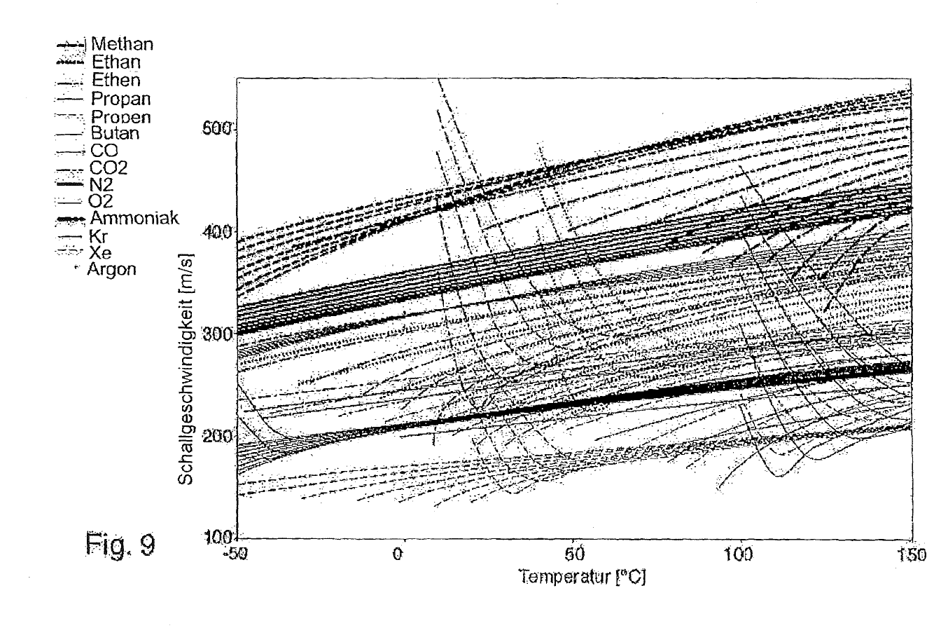

FIG. 9 chart,

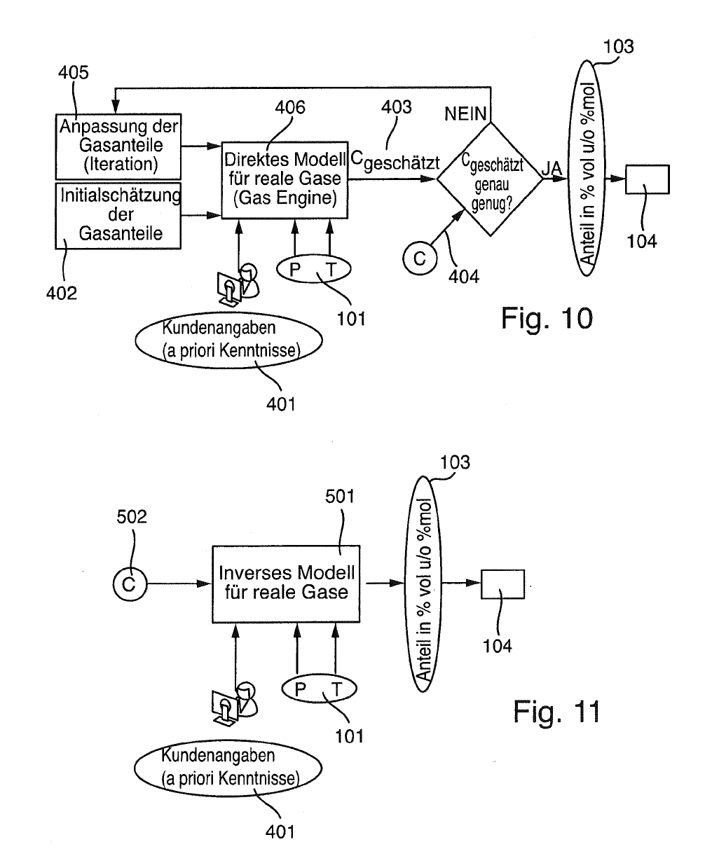

FIG. 10 modeled representation of an iterative solution, and

FIG. 11 modeled representation of an inverse model.

The use of ultrasonic, flow measuring devices 21 for determining the volume- or mass flow Q of a gaseous or liquid medium through a pipeline 1 based on the travel-time difference principle is generally known. Reference is made to the Handbook of T. Stauss (ISBN 3-9520220-4-7). Extensive information is also given in the ‘Durchfluss-Fibel’ (Flow Handbook) published by the applicant. Moreover, ultrasonic, flow measuring devices are sold by the applicant under the designation, PROSONIC FLOW.

FIGS. 1 and 2 show two different embodiments of the apparatus, in the case of which an ultrasonic, flow measuring-device 31 is used for analysis and flow measurement of a gas mixture 2. FIG. 3 shows in detail the ultrasonic sensor and integrated temperature sensor 4 of FIG. 1. FIG. 4 shows in detail the temperature/humidity sensor 7 of FIG. 2. The temperature sensor can be integrated in the ultrasonic sensor. However, it does not have to be integrated in the ultrasonic sensor. Measuring by the integrated temperature sensor can lead to small heat loss errors.

Alternatively, the temperature can be determined earlier and provided as an input value. Thus, the temperature can, for example, be ascertained by a separate measuring unit in front of the flow measuring device.

In both embodiments, two ultrasonic sensors 4, 5 are provided for determining the volume flow Q according to the travel-time difference principle, wherein the two ultrasonic sensors 4, 5 are secured oppositely lying and axially offset relative to one another on the pipeline 1 or on the measuring tube.

Alternatingly, the two ultrasonic sensors 4, 5 ultrasonic, transmit and receive measurement signals. The travel-time difference between the ultrasonic, measurement signals, which are transmitted and received in the stream direction S and counter to the stream direction S, is a measure for the volume flow Q of the gas mixture 2 in the pipeline 1.

An essential difference between the two embodiments shown in FIGS. 1 and 2 is that in the case of the embodiment shown in FIG. 1 it is assumed that the relative humidity RH of the gas mixture amounts to 100% or that the relative humidity is known in advance and provided as information to the device, e.g. as an input value. Thus, concentration of steam in the gas mixture 2 depends only on the temperature T and the corresponding saturation steam pressure can be taken from a table or won via an appropriate formula.

In order to obtain more exact information as regards the steam concentration x_{w}, a pressure sensor 32 is advantageously provided. In the case of real gases, the pressure sensor is especially advantageous, since velocity of sound in real gases is pressure dependent. As a result, the measured pressure enters into ascertaining the concentrations of the gas components. Additionally, based on the measured pressure of the gas mixture 2 in the pipeline 1, which possibly differs from the standard pressure, concentration x_{w} of steam in the gas mixture 2 can be exactly determined.

Alternatively, the pressure can also be known in advance and provided as an input value.

In the case of the embodiment shown in FIG. 2, supplementally to the temperature sensor 7 and, in given cases, the pressure sensor 32, a humidity sensor 15 is provided. The humidity sensor 15 provides a measured value as regards the current relative humidity RH in the gas mixture 2. In this way, the steam concentration x_{w} in the gas mixture 2 can be highly accurately determined. Usually, the humidity sensor 15 is embodied as a capacitive sensor. The fritted glass 16 protects the humidity- and temperature sensor 7 from mechanical destruction; it prevents collision of larger particles.

In FIG. 1 and in the detail view of FIG. 3, it is shown that the temperature sensor 35 is integrated in one of the two ultrasonic sensors 4. Temperature sensor 35 is, for example, an RTD element, a thermistor, a thermocouple or a temperature-sensitive semiconductor element. Temperature sensor 35 is so integrated in the ultrasonic sensor 4 that it measures the temperature T of the gas mixture 2.

The ultrasonic sensor 4 can be composed of a piezoelectric element 13 and a matching layer 14, wherein the matching layer 14 improves the in- and out-coupling of the ultrasonic, measurement signals into and out of the gas mixture 2. Preferably, the matching layer 14 has a thickness, which corresponds to a fourth of the wavelength of the ultrasonic, measurement signals. The matching layer 14 is so embodied that its acoustic impedance lies between the acoustic impedance of the piezoelectric element 13 and the acoustic impedance of the gas mixture 2. The matching layer is, however, not absolutely required for the functionality of the sensor.

The flow velocity V of the gas mixture 2 can be calculated based on the travel-time difference principle according to the following formula:

$$V = K \frac{L}{2 sin θ} \cdot \frac{{t}_{up} - {t}_{dn}}{{t}_{up} \cdot {t}_{dn}} \qquad ( 1 a )$$

The volume flow Q results, then, from the mathematical relationship:

Q=A·V (1b)

The velocity C_{g} of sound in the medium 2 flowing in the pipeline 1, respectively in the measuring tube, can be calculated according to the following formula:

$${C}_{g} = \frac{L}{2} [ \frac{1}{{t}_{up}} + \frac{1}{{t}_{dn}} ] \qquad ( 2 )$$

In such case,

tᵤₚ is the travel time of the ultrasonic, measurement signals in the stream direction S;

t_{dn} is the travel time of the ultrasonic, measurement signals counter to the stream direction S;

K is a function describing the flow profile—in the case of laminar flow, the flow profile usually has the shape of a parabola;

L is the separation between the two ultrasonic sensors 4, 5, respectively the length of the sound path of the ultrasonic, measurement signals between the two ultrasonic sensors 4, 5;

θ is the in-coupling angle of the ultrasonic, measurement signals into the pipeline 1, respectively into the measuring tube, wherein the in-coupling angle equals the out-coupling angle; and

A is the cross sectional area of the pipeline 1, through which the gas mixture 2 is flowing.

In an approximation in this connection, the assumption can be made that the steam in the gas mixture 2 is saturated, i.e. that the relative humidity RH amounts to 100%. Thus, the concentration of steam x_{w}=x₃ can be determined by means of a table or a corresponding formula, in which the steam content, respectively the volume percent of the steam, is listed, respectively calculatable, as a function of temperature T at standard pressure P.

The humidity need not, however, absolutely be 100%. It is sufficient when the humidity is known.

| | saturation steam | volume percent at |
|---|---|---|
| temperature | pressure Ps | standard pressure |
| °in degree C. | in mbar | (1013 mb) in % |
| −10 | 2.86 | 0.3 |
| 0 | 6.11 | 0.6 |
| 10 | 12.2 | 1.2 |
| 20 | 23.3 | 2.3 |
| 30 | 42.3 | 4.2 |
| 40 | 73.5 | 7.3 |
| 50 | 122.9 | 12 |
| 60 | 198.4 | 20 |
| 70 | 310.6 | 31 |
| 80 | 472.7 | 47 |
| 90 | 701.2 | 69 |
| 100 | 1013 | 100 |

If the temperature is known, then the concentration x_{w} of steam can be calculated according to the following formula:

$${x}_{w} = \frac{{P}_{s}}{{P}_{T}}$$

In such case:

P_{S}=the saturated steam pressure as a function of temperature at standard pressure; and

P_{T}=the absolute pressure in the measured medium.

If the relative humidity in the gas mixture is not predetermined, then it is necessary for an exact measurement to determine the relative humidity RH. An arrangement for humidity determination is shown in detail in FIG. 4, where the humidity sensor 15 is embodied together with the temperature sensor 12 as a combined temperature- and humidity sensor 7. Concentration x_{w} of steam can be calculated with knowledge of the current humidity RH according to the following formula:

$${x}_{w} = \frac{{P}_{s} \cdot RH}{{P}_{T }}$$

This formula can also be applied to the extent that the steam in the gas mixture is not saturated and the relative humidity RH not ascertained but, instead, is predetermined as an input value.

FIG. 5 shows the embodiment of the apparatus of FIG. 2 with corresponding control/evaluation circuit 18. Usually, the control/evaluation circuit 18 is integrated in the so-called transmitter of the flow measuring device 31.

The two ultrasonic sensors 4, 5 work alternately as transmitter and receiver. The operating of the ultrasonic sensors 4, 5 occurs via the multiplexer 27. FIG. 5 shows the case, in which the ultrasonic sensor 4 works as transmitter and the ultrasonic sensor 5 as receiver. Via the generator 23 and the transmitting amplifier 25, an electrical excitation signal is applied to the piezoelectric element 13 of the ultrasonic sensor 4. The excitation of the piezoelectric element 13 occurs at its resonant frequency. The ultrasonic sensor 4 is so operated that it transmits a short pulse-shaped, ultrasonic, measurement signal. The optimal frequency of an ultrasonic, measurement signal lies in the region between 50 kHz and 500 kHz.

After a short travel time, the ultrasonic sensor 5 receives the sound pulse. The piezoelectric element 13 of the ultrasonic sensor 5 transduces the sound pulse into an electrical signal; this electrical signal is led to the receiving amplifier 26. The desired amplification is controlled via a feedback circuit 30. The amplified, received signal is converted via an analog/digital converter 24 into a digital signal and the evaluation unit 21 provides for additional processing and evaluation. The evaluation unit 21 calculates the travel time t_{dn} of the sound pulse on the sound path from the ultrasonic sensor 4 to the ultrasonic sensor 5.

Then, the ultrasonic sensors are so operated via the multiplexer 27 that the ultrasonic sensor 5 works as transmitter and the ultrasonic sensor 4 as receiver. In the above described manner, the evaluation unit 21 ascertains the travel time tᵤₚ, which the sound pulse requires, in order to travel the sound path between the ultrasonic sensor 5 and the ultrasonic, sensor 5.

In a memory unit associated with the evaluation unit 21, information concerning the function K is stored, which describes sufficiently exactly the flow profile, respectively the geometry of measuring tube, respectively the pipeline 1, as a function of flow velocity V at least for a substantial number of application cases. As already mentioned above, the function K can also be determined metrologically. For this, more than one pair of ultrasonic sensors 4, 5 are provided on measuring tube, respectively on the pipeline 1.

Based on the measured travel times t_{dn}, tᵤₚ—in given cases, averaged over a number of measuring cycles—and based on the stored function K describing the flow profile, the evaluation unit 21 determines via Equation (1a), Equation (1b) and Equation (2) the flow velocity V, the volume flow Q and the velocity C_{g} of sound in the gas mixture 2.

The temperature values, respectively humidity values, measured by the temperature sensor 35 and, in given cases, the humidity sensor 15 are forwarded from the temperature circuit 20, respectively the humidity circuit 19, to the evaluation unit 21.

As shown in FIG. 5, the temperature circuit and humidity sensor circuit are integrated into the control/evaluation circuit 18. Analogousy, also an optional pressure circuit can be integrated into the control/evaluation circuit. However, the aforementioned circuits of the sensors need not absolutely be integrated into the control/evaluation circuit 18, but, instead, can be autonomous circuits with their own transmitters, which communicate with the transmitter of the flow measuring device via respective interfaces.

Thus, also a combination of circuits integrated with the control/evaluation circuit 18, autonomous circuits and predetermined input values for temperature, pressure and humidity is possible.

Optionally, more sensors, e.g. for determining density and viscosity or gas sensors for determining gases (CO₂, H₂S, . . . sensors) can be provided.

Evaluation unit 21 calculates with application of the measured velocity C_{g} of sound and the additional known variables the volume fractions of the three essential components of the gas mixture. Furthermore, the evaluation unit 21 provides information concerning the volume flow of the individual components of the gas mixture 2. The values are displayed on the display unit 22 or forwarded via correspondingly connected lines to a superordinated process control station.

FIG. 6 shows the arrangement of the apparatus on a fermenter 33 in a plant for producing biogas. Located in the fermenter 33 is material 34 in the form of organic materials, especially food remnants, silage and liquid manure. The fermentation process occurs at a predetermined temperature. The won biogas is led via the removal tube 1 into a gas storer (not shown). Mounted in the removal tube 1 is the ultrasonic, flow measuring device 31.

Preferably, the evaluation unit 21 ascertains the energy flow, respectively the energy production, of the biogas taking into consideration the ascertained concentrations of the individual components and the flow velocity V of the biogas in the pipeline 1. A report is output, when the energy flow, respectively the energy production, of the biogas subceeds a predetermined minimum limit value.

The control/evaluation unit 21 provides control variables, via which temperature in the fermenter 33 and/or charging of the fermenter 33 with the material 34 is controlled. Especially, the fermentation process in the fermenter 33 is so controlled that the energy flow, respectively the energy production, of the biogas assumes an essentially constant value. In this way, the fermentation process can be optimized.

If the plant for producing biogas is composed of a plurality of fermenters 33, then the apparatus 31 controls the temperature of each individual fermenter 33 and/or the charging of each individual fermenter 33 with material 34 in such a manner that the energy flow, respectively the energy production, of the biogas produced by the plant assumes an essentially constant value. In this way, likewise an optimizing of the process in the biogas plant is achieved.

The concept of the invention will now be explained in greater detail.

The above-described FIGS. 1-6 describe, in first line, applications for water-containing gases. In the case of known humidity, the composition and the concentration of the individual components of a ternary gas mixture can be determined.

It is, however, also possible, besides this application, to determine the unknown concentration x₁ and x₂ of two components of any gas mixture. Thus, the composition of a binary gas mixture can be determined. Ternary gas mixtures can be determined when the concentration of a third component x₃ is known. In the case of quaternary gas mixtures, the concentrations of two gas components must be known, in order to determine the gas composition. Correspondingly in the case of n-components, the composition can be determined when the concentrations of n−2 gas components are predetermined or ascertained.

The terminology, ascertain, means in this connection e.g. the active measuring of a gas concentration or the indirect determining of the gas concentration by an ascertained or calculated RH value or dew point.

An example of a ternary gas mixture is the biogas, wherein the one known concentration is the concentration of steam, which is ascertained by means of the RH value and the temperature. This has already been described in detail above.

For the gas analysis, an ultrasonic, flow measuring device is used, in order to determine the fractions (in % mol and/or % vol) of the individual, known gas components. The known fractions can in the next step be output to the customer. Moreover, it serves for calculating diverse properties of the gas mixture, properties such as a e.g. density, specific gravity and viscosity, which likewise can be output or used for calculating derived variables, such as e.g. mass flow, standard volume flow and Reynolds number.

In the case of an ideal gas, the fractions in % vol and in % mol are identical. In the case of real gases, % vol and % mol differ.

FIG. 7 shows a schematic flow diagram for analysis of binary gas mixtures. Starting from the input values of pressure, temperature of the medium and velocity of sound in the gas mixture, after specifying that the number of gas components amounts to two, the fractions in vol. % or mol % can be calculated in an analyzer. For this, the analyzer utilizes the real gas equation. In the case of input of these fractions into a calculator of a data processing unit at known temperature and known pressure of the gas mixture, different values can be ascertained. These values include the mass flow, the standard volume flow, the Reynolds number and higher heating value/lower heating value.

In FIG. 7, there occurs, first of all, the ascertaining of the fractions of the gas components 103 in mol % or vol %. This is done by a binary analyzer for real gases 102. Input to the analyzer 102 are values for the process variables 101. These are in the concrete case the pressure P, the temperature T and velocity of sound c. Additionally, specification 111 of the two gases must occur, e.g. CO₂ and methane.

The input values 101 can be ascertained or predetermined

In this connection, the calculating of the properties of the ascertained gas mixture occurs by means of a mathematical, physical model 104 for real gases with application of the fractions of the gas components and the process variables 101, here only the pressure P and the temperature T. The ascertained properties preferably include the density of the gas mixture 105 under operating conditions, the density of the gas mixture 106 under standard conditions 106, the kinematic or dynamic viscosity of the gas mixture 107 and the higher heating value/lower heating value of the gas mixture 108.

From the ascertained properties 105-108, other process variables 112 can be calculated, especially including mass flow, standard volume flow, Reynolds number and energy flow (power).

FIG. 8 shows a schematic flow diagram for analysis of ternary gas mixtures. Starting from the input values of pressure, temperature of the medium and velocity of sound in the gas mixture, after specification that the number of gas components amounts to three, the fractions in vol. % or mol % can be calculated in an analyzer. First, however, the percentage of the third gas component must be predetermined or ascertained. For this, the analyzer utilizes the real gas equation. Upon input of these fractions in a calculator of a data processing unit, different values can be ascertained at known temperature and known pressure of the gas mixture. These values include the mass flow, the standard volume flow, the Reynolds number and the higher heating value/lower heating value.

In contrast to FIG. 7, FIG. 8 shows an evaluation of a ternary gas mixture with application of a ternary analyzer for real gases 113. Besides inputting process variables 101, additionally the three gas components must be defined, thus e.g. water, CO₂ and methane (for biogas applications). Moreover, also a concentration of one gas component 115 must be known or have been ascertaind.

In the case of the special example of biogas, there occurs not the direct statement of steam in vol. %, but, instead, the steam concentration can occur by ascertaining the relative humidity (given or measured) and the temperature (given or measured). This was described above.

The subsequent ascertaining of the additional process variables 112 occurs analogously to FIG. 7.

An example of a ternary gas mixture is biogas and its variants (clarification plant gas or digester gas, landfill gas) as well as mine gas (coal gas) better known as coal seam gas or coal bed methane. These gases are composed mainly of methane, carbon dioxide and steam. In this case, the fractions, methane and carbon dioxide, are determined by the analyzer and the fraction, steam, is calculated with the assistance of the relative humidity in % (RH) and of the temperature value provided by the customer.

The analyzer uses for determining the gas fractions the velocity of sound c, which can be measured directly by an ultrasonic, flow measuring device, the process pressure P and the process temperature T. There are three options for determining P (pressure) and T (temperature):
direct measurement by integrated P/T sensors,
input by means of analog or digital interfaces of values measured by external P/T sensors, and
input of constant values by the customers.

The state of the art to this point in time starts from the assumption that the gas mixture behaves as an ideal gas. This provides an option of using simple physical models, such as e.g. the thermal state equation of ideal gases. In this “ideal world”, for all gases: velocity of sound is independent of process pressure and rises with the square root of the process temperature.

The assumption of the ideal gas remains true only in a limited pressure- and temperature range. Outside of this range, the physical models for ideal gas behavior become inaccurate and are not suitable for a measuring device, which should achieve a high accuracy of measurement. Depending on gas, the valid range is smaller or larger. Thus, e.g. carbon dioxide, an integral part of biogases, is a strongly “non-ideal” gas, in the case of which already above a process pressure of 10 bar relevant deviations from ideal gas behavior occur.

In the world of real gases, all gases behave differently, especially when large pressure- and temperature ranges are considered. Velocity of sound of a real gas depends both on the process temperature as well as also on the process pressure. These dependencies are complex and differ from gas to gas, such as one can see from the graph of FIG. 9:

FIG. 10 shows a modeled representation of an iterative solution such as implemented e.g. in a binary analyzer 102. The mathematical, physical bases for an Iterative approximation of any measured variable are well known to those skilled in the art. The customer data 401 illustrated in FIG. 10 concern which gas components are in the gas mixture and, for example, in the case of gas mixtures with n-components, the required concentrations of the n−2 gas components.

In the case of FIG. 10, there occurs an initial estimate 402 of the gas fractions of a gas mixture to be measured, as well as the input of pressure and temperature of the medium, which are ascertained e.g. by measuring. By calculation, a velocity of sound 403 is provided based on the estimated gas fractions. This is compared with the actually measured velocity of sound 404. Then, the gas fractions are iteratively adapted 405 until the calculated velocity of sound agrees with the measured velocity of sound. Then, an output of the mol percents and/or volume percents occurs.

In this variant, the gas fractions Xi are, thus, determined with the assistance of an iterative process. Ths process minimizes error in the estimated velocity of sound c_{estimated}. The number of possible minimizing algorithms is large and extends from classic gradient-methods to modern evolution algorithms. Preferably selected for measuring devices, however, are algorithms, which have a suitable speed of convergence and a small calculative effort.

The velocity of sound c_{estimated} is calculated for the current estimation of the gas fractions X_{i,k} with the assistance of a direct model 406, such as e.g. a software:

c_{estimated,k}=f(P, T, X_{i,k})

wherein k is the iteration index. For description of the software package, see “NEL40—A FORTRAN Software Package for the Thermodynamic and Transport Properties of 40 Common Fluids and their Mixtures”, TUV NEL, 2005.

In the practical implementation, the iterative process can run as an “endless loop”. Therewith, the ascertained gas fractions Xi are continuously matched to the changes in the process variables P, T, c.

A second variant of the analysis of a gas mixture is shown in FIG. 11.

In this variant, it is assumed that an inverse model 501 for real gases is present, with which one can calculate from the process variables 101 P, T, thus pressure and temperature, and the process variable 502 c, thus velocity of sound, with the assistance of customer data (a priori knowledge) directly, thus without iteration, the individual gas fractions Xᵢ:

Xᵢ=f(P, T, c)

Since we must assume that the derivation of a generally valid inverse model would be very complicated or impossible, instead, defined inverse models can be developed, which are true only in a limited range. Depending on case of application, respectively customer's benefit, defined inverse models can be developed for a limited pressure range, a limited temperature range and/or only for certain gas components. Mentioned as an example, can be a defined inverse model for biogas in the form of a real gas.

The defined model changes from gas mixture to gas mixture, from temperature range to temperature range and from pressure range to pressure range and can be tailored to the customer's wishes.

Alternatively to the aforementioned determining of the steam by the relative humidity RH, also an ascertaining by means of the dew point can occur.

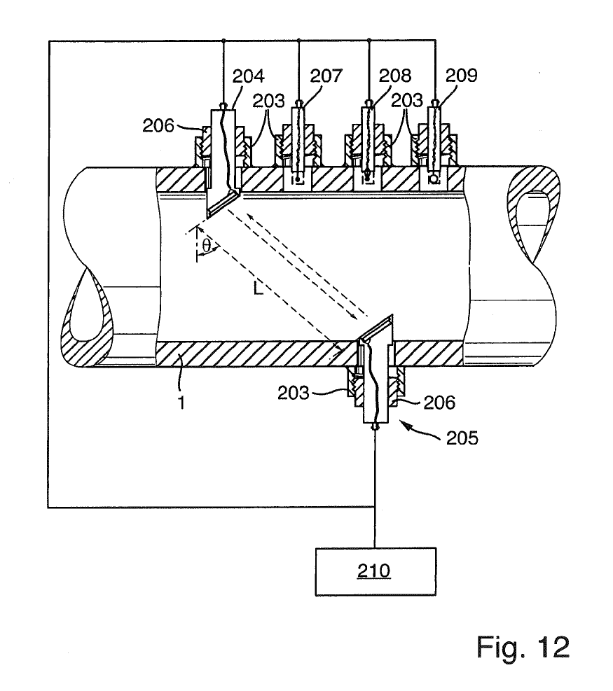

FIG. 12 shows another embodiment of an apparatus of the invention. This includes a measuring tube 201, through which a measured medium 202, thus e.g. a ternary gas mixture, is led. Arranged on measuring tube 201 are sensor nozzles 203. These serves both for accommodating two ultrasonic transducers 204 and 205 as well as also a pressure sensor 207, a temperature sensor 208 and an optional humidity sensor 209, to the extent that the gas mixture is essentially a ternary gas mixture with steam as a component. In such case, included is a nozzle 203 for each of the ultrasonic transducers 204, 205 and the sensors 207-209. These are connected with a connection adapter 306, for example, a screw adapter, which can be introduced into the respective nozzles. The sensors are connected via data lines with an evaluation unit 210. Of course, the communication between the ultrasonic transducers and/or the sensors with the evaluation unit 210 can also occur via a cableless (wireless) data connection.

Also, a number of evaluating units can be provided, which communicate with one another.

The evaluation unit ascertains from the measured values of the sensors 207-209 and the ultrasonic transducers 204, 205 the composition of the gas mixture and, in given cases, the flow velocity and/or the volume flow of the gas mixture.

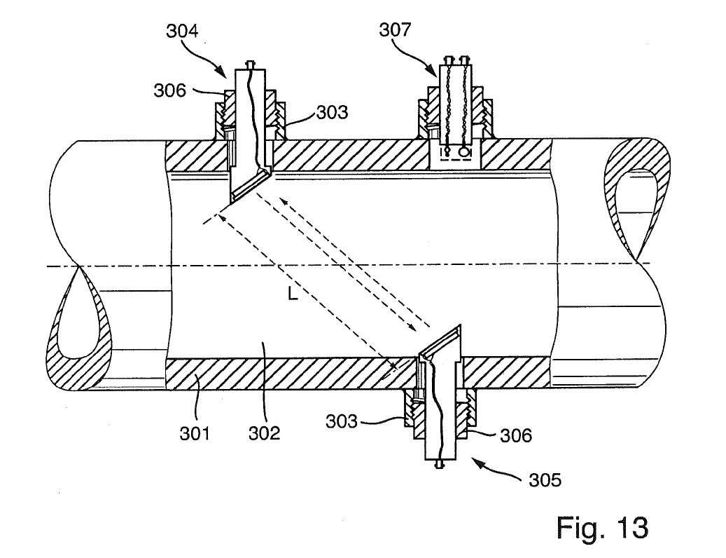

FIG. 13 shows another embodiment of an apparatus of the invention. In such case, once more a measuring tube 301 is provided, through which a measured medium 302, especially a gas mixture, flows. Also, in this embodiment, the measuring tube 301 includes two nozzles for the ultrasonic transducers 304 and 305, which are fixed with the assistance of connection adapters 306 in the respective nozzles 303. Measuring tube 301 additionally includes an extra nozzle 303, into which a combination sensor 307 can be introduced. This combination sensor 307 brings together at least two of the three sensors 207-209 and enables therewith a temperature- and pressure measurement or a temperature- and humidity measurement or a pressure- and humidity measurement. The measurement data can then, as in FIG. 12, be transmitted to an evaluation unit.

The nozzle for the combination sensor is available to the end user. It does not, however, have to be used, to the extent that the process data can be provided to the evaluation unit from other measuring points not integrated into the measuring device.

1. Apparatus for determining two unknown concentrations (x₁,x₂) of components of a gas mixture (2) flowing through a pipeline (1), wherein the gas mixture (2) is composed of at least two components, wherein an ultrasonic, flow measuring device (31) is provided, which determines velocity (C_{g}) of sound of the gas mixture (2) flowing in a pipeline (1), and wherein an evaluation unit (21) is provided, which, based on velocity of sound (C_{g}) ascertained via ultrasonic measurement, an ascertained or predetermined pressure (P) of the medium and an ascertained or predetermined temperature (T) of the medium, and based on a mathematical, physical model for real gases, determines the two unknown concentrations (x₁,x₂) of the components of the gas mixture (2).

2. Apparatus as claimed in claim 1, wherein the gas mixture (2) is composed essentially of three components, of which one is steam, wherein the evaluation unit (21) ascertains concentration (x₃) of steam as a function of temperature (T) and humidity (RH) of the gas mixture (2) and takes into consideration the concentration (x₃) of steam in determining the concentrations (x₁, x₂) of the two additional components.

3. Apparatus as claimed in claim 2, wherein the gas mixture (2) is a gas mixture essentially composed of the components, hydrocarbon compounds, carbon dioxide and steam.

4. Apparatus as claimed in claim 3, wherein the hydrocarbon compound is an alkane, alkyne or alkene.

5. Apparatus as claimed in claim 3, wherein the hydrocarbon compound is methane.

6. Apparatus as claimed in claim 1, wherein the evaluation unit (21) ascertains the concentration(x₃) of steam as a function of temperature (T) assuming a relative humidity (RH) of 100%.

7. Apparatus as claimed in claim 1, wherein a humidity measuring unit (15) is provided, which measures relative humidity (RH) of the gas mixture (2) flowing in the pipeline (1) and wherein the evaluation unit (21) determines concentration (x₃) of steam as a function of temperature (T) and measured relative humidity (RH).

8. Apparatus as claimed in claim 1, wherein pressure (P) in the pipeline (1) is taken into consideration in determining concentration (x₃) of steam in the gas mixture (2) and/or in evaluating velocity of sound (Cₜ) based on the real gas equation.

9. Apparatus as claimed in claim 1, wherein a pressure sensor (32) is provided, which determines absolute pressure of the gas mixture (2) flowing in the pipeline (1) and wherein the evaluation unit (21) takes measured absolute pressure into consideration in determining concentration (x₃) of steam in the gas mixture (2) and/or in ascertaining velocity of sound (Cₜ) based on the real gas equation.

10. Apparatus as claimed in claim 1, characterized in that the flow measuring device has a control/evaluation circuit (18) and a circuit (20) of the temperature sensor is integrated into the control/evaluation circuit (18).

11. Apparatus as claimed in claim 1, characterized in that the measuring tube (1) has a mechanical interface, especially a bore hole or a connection nozzle, for mounting a pressure sensor (32) on or in the measuring tube (1).

12. Apparatus as claimed in claim 1, characterized in that the measuring tube (1) has a pressure sensor (32), which is fixed on or in the measuring tube, especially via the interface as claimed in claim 11 and data transfer between the pressure sensor (32) and the control/evaluation circuit (18) occurs via an analog or digital interface, especially a 4 . . . 20 mA data transfer interface or a HART data transfer interface.

13. Apparatus as claimed in claim 1, characterized in that the evaluation unit (21) ascertains the two unknown concentrations of the gas mixture (2) taking into consideration the type of the gas components, which are provided as input values.

14. Apparatus as claimed in claim 1, characterized in that the evaluation unit (21) ascertains the two unknown concentrations (x₁,x₂) of the gas components of the gas mixture (2) taking into consideration a third to n-th concentration of additional gas components of the gas mixture (2), which concentrations are provided as input values or, in the case of water content, ascertained, in given cases, based on relative humidity (RH) or based on dew point.

15. Apparatus as claimed in claim 1, wherein the pipeline (1) is a removal tube for the gas mixture (2), respectively for the biogas, and wherein the pipeline (1) is arranged in the upper region of a fermenter (33), into which biomaterial (34) is charged.

16. Apparatus as claimed in claim 1, wherein the ultrasonic, flow measuring device (31) is so embodied that it ascertains flow velocity of the gas mixture (2) flowing in the pipeline (1) via the Doppler- or the travel-time difference principle.

17. Apparatus as claimed in claim 1, wherein the evaluation unit (21), based on the ascertained concentrations (x₁,x₂, x₃) and the molecular weights (M₁, M₂, M₃) of the individual components of the gas mixture (2), respectively of the biogas, and based on the ascertained flow velocity, ascertains volume- or mass flow (Q) of at least one of the components of the gas mixture (2), respectively of the biogas.

18. Apparatus as claimed in claim 1, wherein the evaluation unit ascertains and provides the energy flow, respectively the energy production, of the biogas taking into consideration the ascertained concentration (x₁, x₂, x₃) of the individual components and the flow velocity of the biogas (2) in the pipeline (1).

19. Apparatus as claimed in claim 1, wherein a display unit (22) is provided, which outputs a report, when the energy flow, respectively the energy production, of the biogas (2) subceeds a predetermined minimum limit value.

20. Apparatus as claimed in claim 1, wherein a controller (18) is provided, which so controls temperature (T) in the fermenter and/or charging of the fermenter with material (34) that the energy flow, respectively the energy production, (P) of the biogas (2) assumes an essentially constant value.

21. Apparatus as claimed in claim 1, wherein a plant for producing biogas (2) is composed of a plurality of fermenters (33) and wherein the controller (18) so controls the temperature of each fermenter (33) and/or the charging of each fermenter (33) with material (34) that the energy flow, respectively energy production, (P) of the biogas produced by the plant (2) assumes an essentially constant value.

22. Apparatus as claimed in claim 1, wherein the ascertaining of individual components of the gas mixture occurs by iterative calculations based on predetermined starting values.

23. Method for determining concentrations (x₁,x₂, x₃) of gaseous components of a gas mixture (2), which flows through a pipeline (1), wherein the gas mixture (2) is composed essentially of two or three components, wherein velocity (C_{g}) of sound of the gas mixture (2) flowing in a pipeline (1) is determined via an ultrasonic, measuring method, wherein the temperature (T) of the gas mixture (2) flowing in the pipeline (1) is determined, and wherein based on the velocity (C_{g}) of sound ascertained via the ultrasonic, measuring method and based on velocity (Cₜ) of sound resulting from evaluation of the real gas equation, the concentrations of at least two (x₁,x₂) of the components of the gas mixture (2) are determined.

24. Method as claimed in claim 23, wherein the gas mixture (2) is composed essentially of three components, of which one is steam, wherein the evaluation unit (21) ascertains concentration of steam (x₃) as a function of temperature (T) and humidity (RH) of the gas mixture (2) and the concentration (x₃) of steam is taken into consideration in determining concentrations (x₁,x₂) of the two additional components.

25. Method as claimed in claim 23, wherein the energy flow, respectively energy production, (P) of the gas mixture (2) is determined taking into consideration the concentrations (x₁,x₂, x₃) of the individual components and the volume- or mass flow (Q) through the pipeline (1).

26. Use of an apparatus as claimed in claim 1 for ascertaining two unknown concentrations of a gas mixture, which flows through a pipeline, wherein the pressure of the medium in the pipeline amounts to more than 10 bar, preferably more than 20 bar.
